(19) United States
(12) Patent Application Publication
(10) Pub. No.: US 2022/0230073 A1
(43) Pub. Date: Jul. 21, 2022

(54) COMPUTER-READABLE RECORDING MEDIUM STORING DISPLAY PROGRAM, INFORMATION PROCESSING APPARATUS, AND DISPLAY METHOD

(71) Applicant: FUJITSU LIMITED, Kawasaki-shi (JP)

(72) Inventors: Shinichiro Tago, Shinagawa (JP); Fumihito NISHINO, Koto (JP)

(73) Assignee: FUJITSU LIMITED, Kawasaki-shi (JP)

(21) Appl. No.: 17/517,267

(22) Filed: Nov. 2, 2021

(30) Foreign Application Priority Data
Jan. 20, 2021 (JP) 2021-007512

(51) Int. Cl. G06N 5/02; G06K 9/62; G06F 16/36

(52) U.S. Cl. CPC G06N 5/02; G06F 16/367; G06K 9/6265

(57) ABSTRACT

A non-transitory computer-readable recording medium stores a display program for causing a computer to execute a process including: acquiring a contribution degree associated with each of relations between a plurality of nodes included in a graph structure indicating the relations between the nodes with respect to an estimation result of a machine learning model; and displaying a graph in which, within the graph structure, a first structure indicating a first class to which one node or a plurality of nodes belongs and a second structure indicating a first node that belongs to the first class and has the associated contribution degree being equal to or larger than a threshold, are coupled to each other.

### CROSS-REFERENCE TO RELATED APPLICATION

This application is based upon and claims the benefit of priority of the prior Japanese Patent Application No. 2021-7512, filed on Jan. 20, 2021, the entire contents of which are incorporated herein by reference.

### FIELD

The embodiments discussed herein are related to a technique for graphing estimation results of machine learning models.

### BACKGROUND

In various fields, events, cases, phenomena, actions, and the like are estimated using machine learning models generated by machine learning such as deep learning. Such machine learning models are often black boxes, which makes it difficult to explain the grounds for the estimations. In recent years, there has been known a technique in which a machine learning model is generated by machine learning using graph data, as training data, representing relations between pieces of data, and at a time of estimating a graph structure using the machine learning model, contribution degrees leading to the estimation are assigned and output to nodes, edges (relations between nodes), and the like of the graph.

Japanese Laid-open Patent Publication No. 2016-212838; and International Publication Pamphlet No. WO 2015/071968 are disclosed as related art.

### SUMMARY

According to an aspect of the embodiments, a non-transitory computer-readable recording medium stores a display program for causing a computer to execute a process including: acquiring a contribution degree associated with each of relations between a plurality of nodes included in a graph structure indicating the relations between the nodes with respect to an estimation result of a machine learning model; and displaying a graph in which, within the graph structure, a first structure indicating a first class to which one node or a plurality of nodes belongs and a second structure indicating a first node that belongs to the first class and has the associated contribution degree being equal to or larger than a threshold, are coupled to each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing an information processing apparatus according to Embodiment 1;

FIG. 2 is a diagram describing a reference technique;

FIG. 3 is a diagram describing the generation of a graph structure in consideration of a contribution degree;

FIG. 4 is a functional block diagram illustrating a functional configuration of an information processing apparatus according to Embodiment 1;

FIG. 5 is a diagram describing an example of training data;

FIG. 6 is a diagram describing an example of estimation data;

FIG. 7 is a table illustrating an example of information stored in an ontology DB;

FIG. 8 is a table illustrating an example of information stored in a template DB;

FIG. 9 is a diagram describing a relation between an ontology and a template;

FIG. 10 is a table describing an estimation result stored in an estimation result DB;

FIG. 11 is a table illustrating an example of information stored in a display format DB;

FIG. 12 is a table describing knowledge insertion;

FIG. 13 is a diagram describing display of an ontology;

FIG. 14 is a diagram describing visualization determination of a mutation;

FIG. 15 is a diagram describing visualization determination of a DB;

FIG. 16 is a diagram describing visualization determination of a DB;

FIG. 17 is a diagram describing visualization of the DB;

FIG. 18 is a diagram describing visualization determination of a DB;

FIG. 19 is a diagram describing visualization determination of a storage score;

FIG. 20 is a diagram describing visualization determination of a structure change score;

FIG. 21 is a diagram describing visualization of a structure change score;

FIG. 22 is a diagram describing visualization determination of a frequency score;

FIG. 23 is a diagram describing a contribution degree calculation of each edge of a first structure of visualization graph data;

FIG. 24 is a diagram describing a display example of visualization graph data;

FIG. 25 is a flowchart illustrating a flow of a visualization process; and

FIG. 26 is a diagram describing an example of a hardware configuration.

### DESCRIPTION OF EMBODIMENTS

However, for example, in a case of large-scale graph data in which the number of nodes is enormously large, for example, since a contribution degree is assigned to each node, the amount of information becomes enormous, which makes it difficult to understand the nodes having a large contribution degree to the estimation.

In one aspect, an object is to provide a computer-readable recording medium storing therein a display program, an information processing apparatus, and a display method that are capable of outputting information with which grounds for estimations by a machine learning model may be easily understood.

Hereinafter, embodiments of a computer-readable recording medium storing a display program therein, an information processing apparatus, and a display method that are disclosed in the present application will be described in detail with reference to the drawings. Note that the embodiments do not limit the present disclosure. The embodiments may be combined with each other as appropriate within the scope without contradiction.

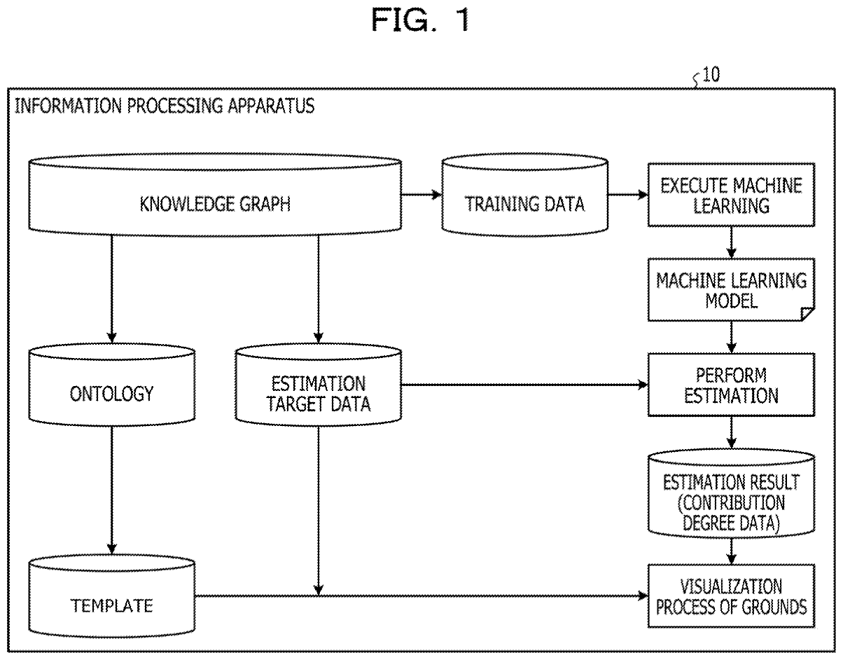

FIG. 1 is a diagram describing an information processing apparatus 10 according to Embodiment 1. The information processing apparatus 10 illustrated in FIG. 1 generates a machine learning model by machine learning using training data having a graph structure, inputs estimation target data to the machine learning model, and acquires an estimation result including contribution degrees leading the machine learning model to the estimation. Then, the information processing apparatus 10 aggregates nodes included in the estimation result based on the contribution degrees, thereby outputting information with which the grounds for the estimation by the machine learning model may be easily understood. In the embodiment, an example is described in which a machine learning model is used to estimate whether a graph structure including one node or a plurality of nodes related to a “mutation A”, which is an example of a case, causes a disease (pathogenic or benign).

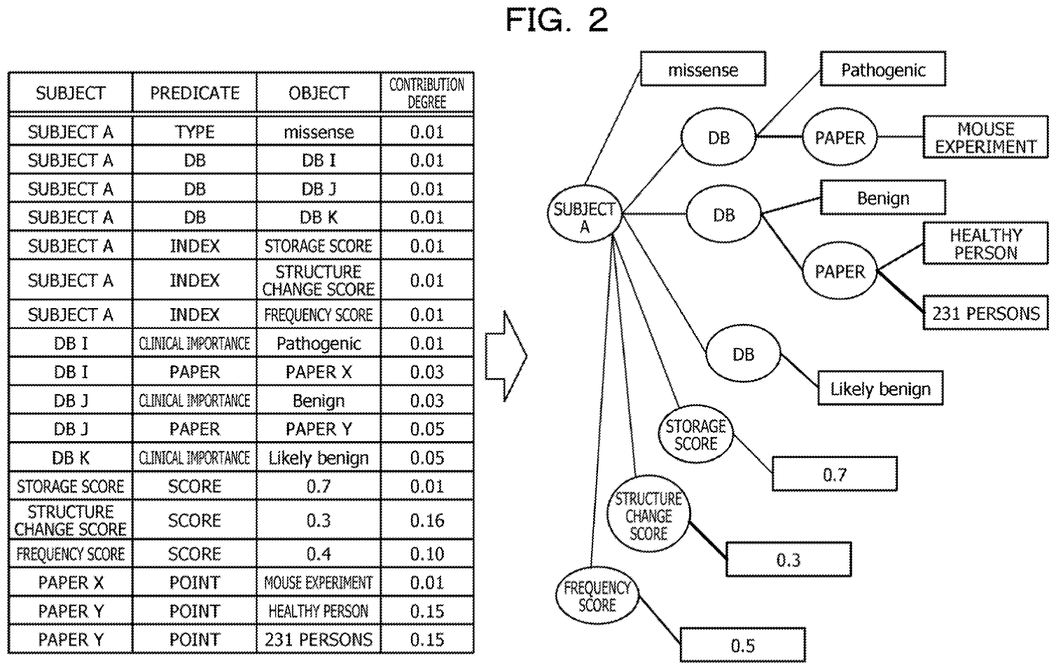

A reference technique for outputting an estimation result of a machine learning model will be described below. FIG. 2 is a diagram describing a reference technique. In the reference technique illustrated in FIG. 2, estimation target data, which is an example of a feature graph, is input to a machine learning model having experienced machine learning so as to obtain an estimation result. For example, the machine learning model is a model for estimating whether a mutation A is pathogenic or benign. The estimation target data is graph-structured data (hereinafter, may be described as graph data) indicating a relation between nodes, which is generated using a triple (subject, predicate, object) that is a set of three elements (two nodes and an edge) acquired from a knowledge graph.

In the reference technique, the estimation target data is input to the machine learning model, and then an estimation result for each node and a contribution degree with respect to a relation (edge) between nodes are acquired. In the reference technique, a contribution ratio to the estimation is displayed by changing a color, thickness, and the like of the edge between the nodes in accordance with the magnitude of the contribution degree. However, in the reference technique, in a case where the estimation target data has a large-scale graph structure, it is difficult to understand the nodes having a large contribution degree to the estimation, and the entirety of the graph structure may not be displayed depending on the size of the display, so that convenience for the user is not good.

In contrast, the information processing apparatus 10 according to Embodiment 1 outputs an estimation result that makes it easy by using contribution degrees to understand the grounds for the estimation by the machine learning model. For example, as illustrated in FIG. 1, the information processing apparatus 10 generates the training data from the knowledge graph, and generates the machine learning model by machine learning using the training data. On the other hand, the information processing apparatus 10 generates, from the knowledge graph, an ontology that defines triples belonging to a first structure to be visualized, the estimation target data, and the like. The information processing apparatus 10 uses an extraction model having experienced machine learning or the like to generate, from the ontology, a template that defines triples easily understood by a person.

The information processing apparatus 10 inputs the estimation target data to the machine learning model to acquire the estimation result including the contribution degrees. Thereafter, the information processing apparatus 10 performs a visualization process of estimation grounds for the estimation result.

For example, the information processing apparatus 10 acquires a contribution degree associated with each of relations (edges) between a plurality of nodes included in a graph structure indicating the relations between the nodes with respect to the estimation result of the machine learning model. Then, the information processing apparatus 10 displays a graph in which, within the graph structure, the first structure indicating a first class to which one node or a plurality of nodes belongs and a second structure indicating a first node that belongs to the first class and has the associated contribution degree being equal to or larger than a threshold, are coupled to each other.

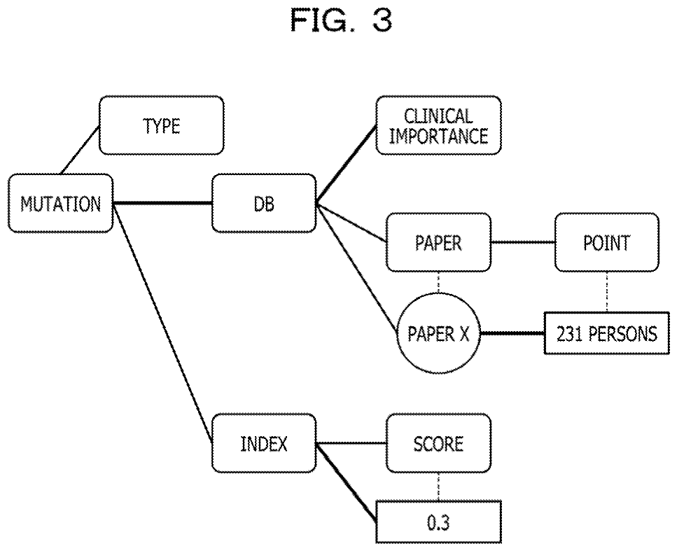

FIG. 3 is a diagram describing the generation of a graph structure in consideration of contribution degrees. As illustrated in FIG. 3, the information processing apparatus 10 determines whether to include the node in the first structure representing a class or in the second structure representing a single node depending on whether the contribution degree having contributed to the estimation of the machine learning model is equal to or larger than the threshold, and generates the graph by coupling those structures. The information processing apparatus 10 may appropriately select the nodes to be included in the second structure in consideration of the fact that excessively reducing the information makes it difficult to facilitate the understanding.

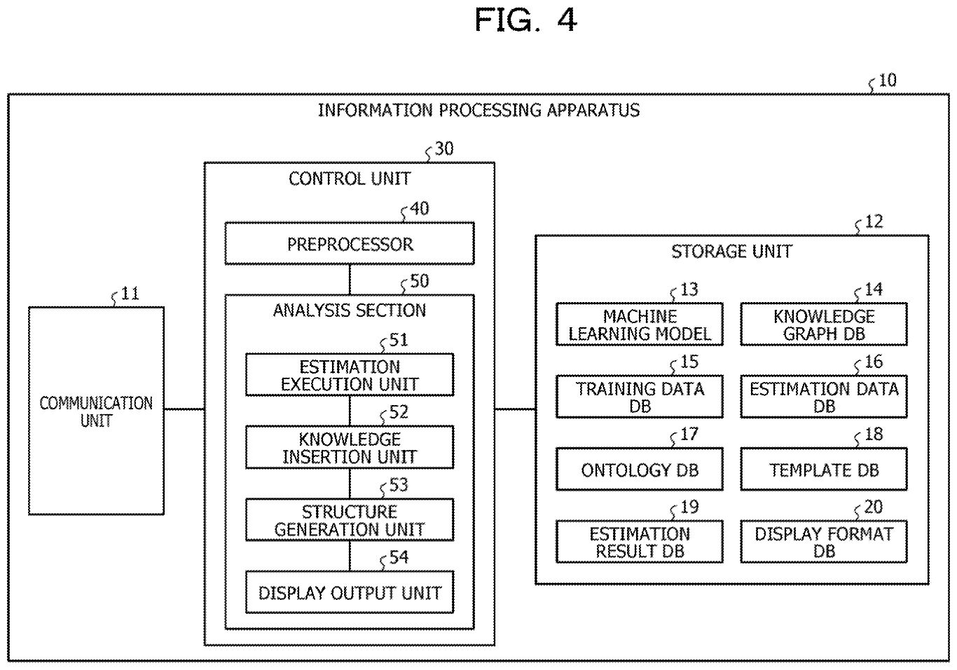

Next, a functional configuration of the information processing apparatus 10 will be described. FIG. 4 is a functional block diagram illustrating the functional configuration of the information processing apparatus 10 according to Embodiment 1. As illustrated in FIG. 4, the information processing apparatus 10 includes a communication unit 11, a storage unit 12, and a control unit 30.

The communication unit 11 controls communications with other apparatuses. For example, the communication unit 11 receives a knowledge graph and the like from an external server, receives various types of data, various types of instructions, and the like from an administrator terminal or the like used by an administrator, and transmits generated graph data to the administrator terminal.

The storage unit 12 stores various types of data, programs to be executed by the control unit 30, and the like. For example, the storage unit 12 stores a machine learning model 13, a knowledge graph DB 14, a training data DB 15, an estimation data DB 16, an ontology DB 17, a template DB 18, an estimation result DB 19, and a display format DB 20.

The machine learning model 13 is a model generated through machine learning executed by the information processing apparatus 10. For example, the machine learning model 13 is a model using a deep neural network (DNN) or the like, and may employ other machine learning, deep learning, and the like. The machine learning model 13 is a model that outputs an estimation value “Pathogenic or Benign” and a contribution degree of each node with respect to the estimation value. For example, Local Interpretable Model-agnostic Explanations (LIME), Shapley Additive exPlanations (SNAP), and the like may be employed as the machine learning model 13.

The knowledge graph DB 14 stores graph data about knowledge. The knowledge is expressed by a set of three elements, or a so-called triple such that “for a s (subject), a value (object) of r (predicate) is o”. Note that “s” and “o” may be referred to as entities, and “r” may be referred to as a relation.

The training data DB 15 stores a plurality of pieces of training data used for machine learning of the machine learning model 13. For example, each training data stored in the training data DB 15 is data in which “graph data” and “teacher labels” are associated with each other, and is data which is generated from the knowledge graph. The training data may be generated using another machine learning model or may be generated manually by an administrator or the like.

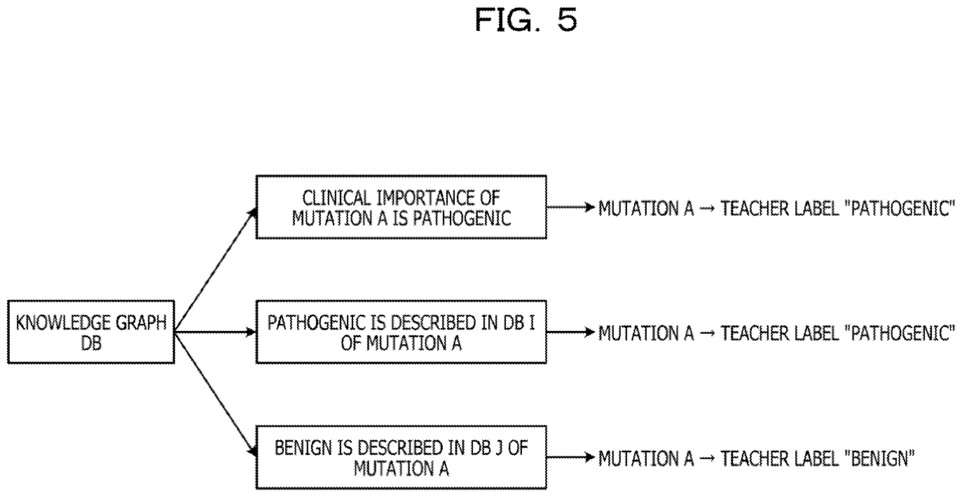

FIG. 5 is a diagram describing an example of the training data. As illustrated in FIG. 5, the information processing apparatus 10 acquires, from the knowledge graph DB 14, that “clinical importance (r: predicate) of the mutation A (s: subject) is Pathogenic (o: object)”. In this case, a teacher label “Pathogenic” is set for the “mutation A”.

Similarly, the information processing apparatus 10 acquires, from the knowledge graph DB 14, “in a DB I (r: predicate) of the mutation A (s: subject), Pathogenic (o: object) is described”. In this case, the teacher label “Pathogenic” is set for the “mutation A”.

Further, the information processing apparatus 10 acquires, from the knowledge graph DB 14, “in a DB J (r: predicate) of the mutation A (s: subject), Benign (o: object) is described”. In this case, a teacher label “Benign” is set for the “mutation A”.

As discussed above, the information processing apparatus 10 generates, from the knowledge graph DB 14, the training data in which “graph data” including the “mutation A” is associated with the “teacher labels” determined based on the graph data.

The estimation data DB 16 stores estimation target data 16a to be estimated by using the machine learning model 13, and class data 16b related to the class to which each node acquired from the knowledge graph belongs.

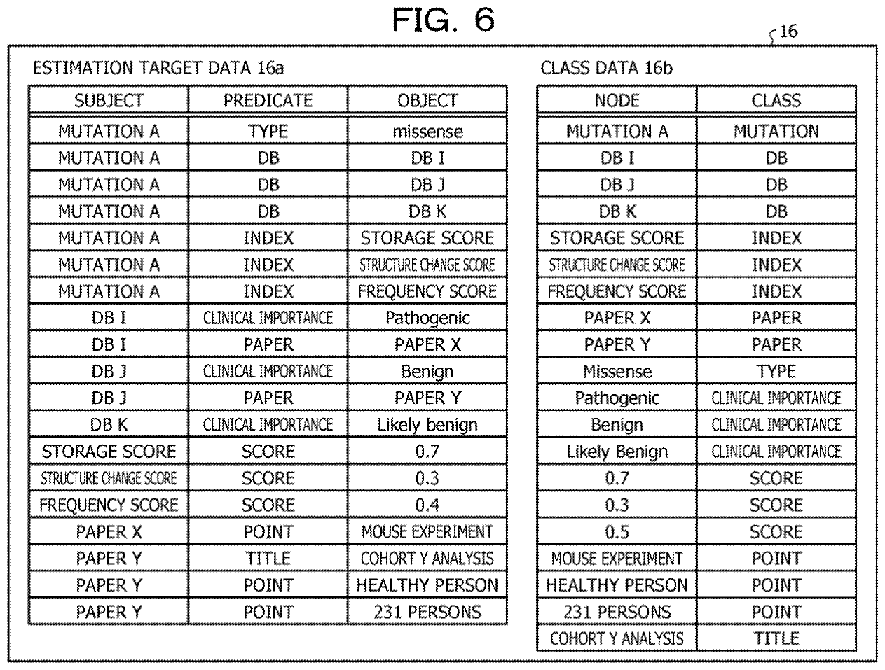

FIG. 6 is a diagram describing an example of the estimation data. As illustrated in FIG. 6, the estimation target data 16a is information in which “subject, predicate, and object” are associated with one another. “Subject” and “object” indicate instances, and “predicate” indicates a relation between two instances. An example in FIG. 6 indicates that a node “mutation A” as a subject and a node “missense” as an object are coupled by an edge (relation between nodes) of a predicate “type”. Although FIG. 6 illustrates the estimation target data 16a in a tabular form, the estimation target data 16a may be graph data. The estimation target data 16a may be generated by using another machine learning model, or may be generated manually by an administrator or the like.

As illustrated in FIG. 6, the class data 16b is data in which “node” and “class” are associated with each other. “Node” is data corresponding to a subject included in the knowledge graph, and “class” is a class to which the node belongs. For example, in the case of FIG. 6, it is indicated that the node “mutation A” belongs to a class “mutation”, and nodes “DB I”, “DB J”, and “DB K” each belong to a class “DB”. Although the class data 16b in a tabular form is illustrated in FIG. 6, the class data 16b may be graph data. The class data 16b may be generated by using another machine learning model, or may be generated manually by an administrator or the like.

The ontology DB 17 stores an ontology that is the first structure indicating the first class to which the node to be visualized belongs. For example, the ontology is information on a cluster of nodes to be subjected to machine learning, and is information on a feature graph for explaining estimation grounds of the machine learning model 13. For example, the ontology may be generated using aggregate nodes obtained by aggregating the nodes, the contribution degrees of which included in the estimation result of the machine learning model 13 are less than a threshold.

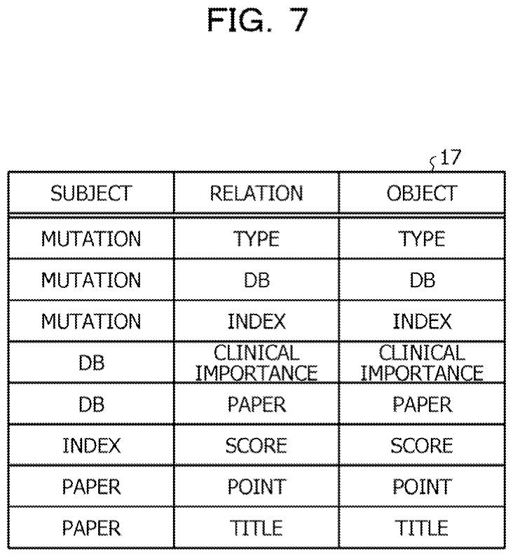

FIG. 7 is a table illustrating an example of information stored in the ontology DB 17. As illustrated in FIG. 7, “subject, relation, and object” are stored being associated with one another in the ontology DB 17. “Subject” and “object” stored here indicate classes, and “relation” indicates a relationship between classes. An example in FIG. 7 indicates that a class “mutation” and a class “type” are coupled by a relation “type”. The class “mutation” and a class “DB” are coupled by a relation “DB”, and the class “mutation” and a class “index” are coupled by a relation “index”. The ontology stored here is generated by an administrator or the like.

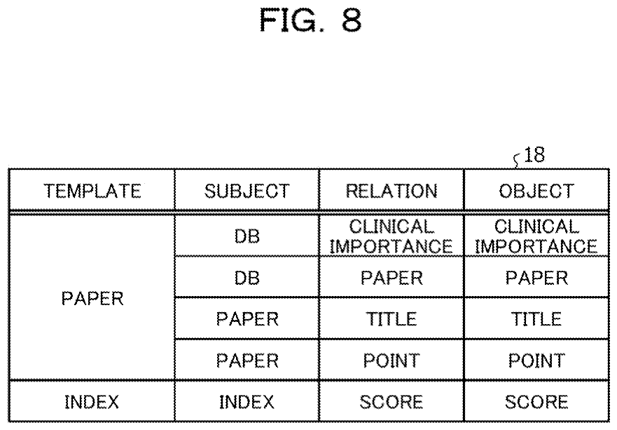

The template DB 18 stores a template, which is data based on the ontology and defines a group (cluster) of nodes assumed to be easily understood. FIG. 8 is a table illustrating an example of information stored in the template DB 18. As illustrated in FIG. 8, the template DB 18 stores templates, in each of which “subject, relation, and object” are associated with one another. Since the “subject, relation, and object” are the same as those in FIG. 7, detailed descriptions thereof will be omitted.

As illustrated in FIG. 8, a template “paper” defines “DB, clinical importance, clinical importance”, “DB, paper, paper”, “paper, title, title”, and “paper, point, point” as “subjects, relations, objects”. A template “index” defines “index, score, score” as “subject, relation, object”.

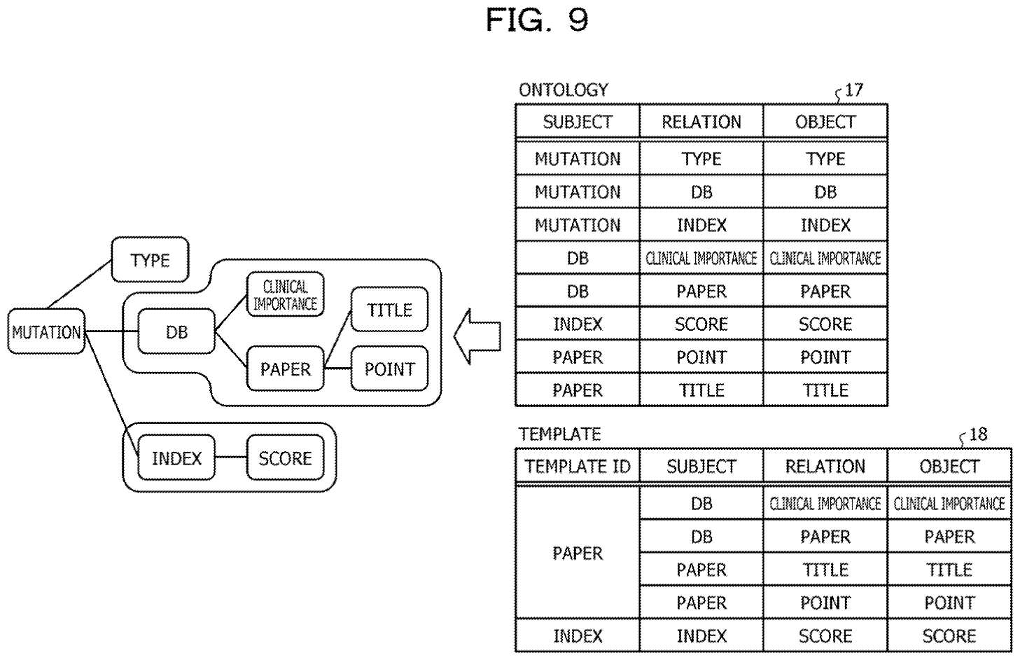

The relation between the ontology and the template will be described below. FIG. 9 is a diagram describing the relation between the ontology and the template. As illustrated in FIG. 9, in a feature graph generated based on the ontology, a graph structure included in a region surrounded by a line corresponds to the template. For example, it is indicated that, as the grounds for the estimation result “Pathogenic or Benign” with respect to the class “mutation”, the evaluation of each class having a predetermined relation with the class “DB”, the evaluation of each class having a predetermined relation with the class “index”, and the like serve as information that helps the user understand the estimation result.

The estimation result DB 19 stores an estimation result obtained by inputting the estimation target data 16a to the machine learning model 13 having experienced machine learning. For example, the estimation result DB 19 stores an estimation result including the estimation value “Pathogenic or Benign” and the contribution degree of each triple with respect to the estimation value, which are obtained by inputting the estimation target data 16a illustrated in FIG. 6 to the machine learning model 13.

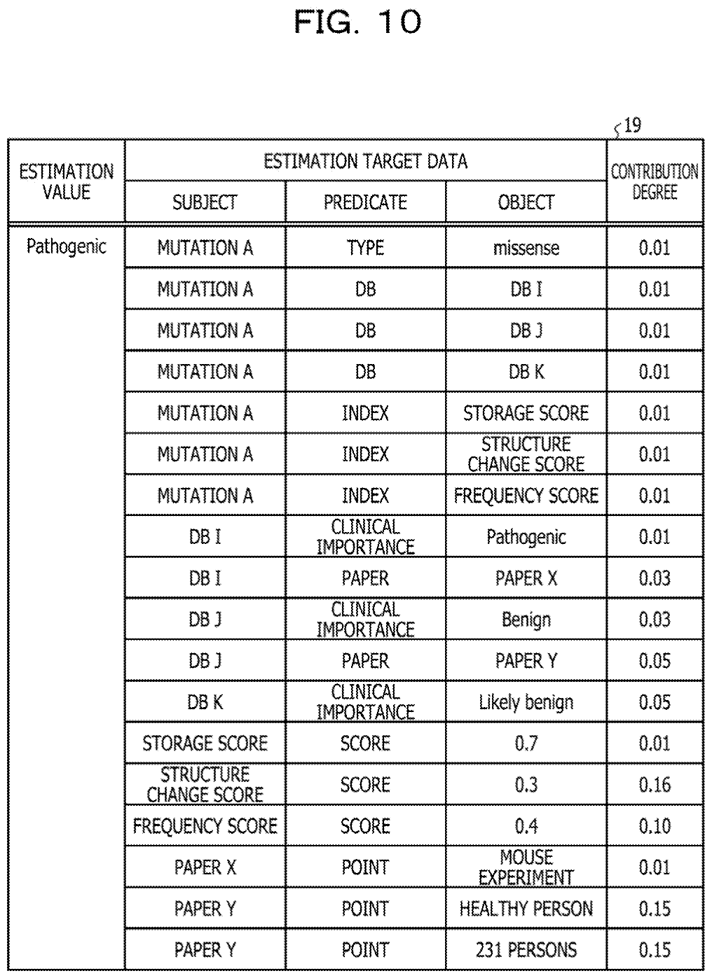

FIG. 10 is a table describing an estimation result stored in the estimation result DB 19. As illustrated in FIG. 10, the estimation result DB 19 stores information in which an estimation value is associated with estimation target data. The “estimation value” stored here is an estimation value of the machine learning model 13, and is “Pathogenic” or “Benign” in this embodiment. The “estimation target data” is estimation target data to be input to the machine learning model 13. “Contribution degree” is a contribution degree of each triple to the estimation value.

FIG. 10 illustrates an example in which the estimation value “Pathogenic” is acquired with respect to the estimation target data 16a illustrated in FIG. 6. It is indicated that the contribution degree to the estimation value “Pathogenic” of a triple “mutation A, type, missense” in the estimation target data 16a is “0.01”.

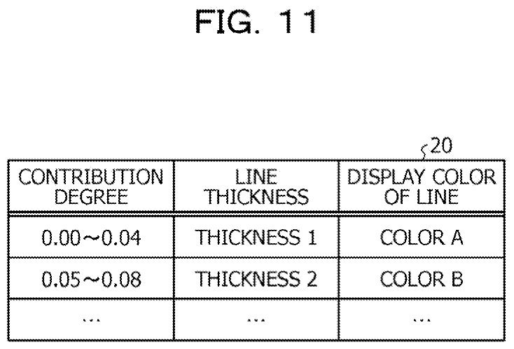

The display format DB 20 stores information in which the display format of the feature graph is defined. For example, the display format DB 20 stores definition information for changing a thickness, display color, and the like of each edge of the graph in accordance with the contribution degree. FIG. 11 is a table illustrating an example of information stored in the display format DB 20.

As illustrated in FIG. 11, “contribution degree, line thickness, and display color of line” are stored being associated with one another in the display format DB 20.

The “contribution degree” stored here is a contribution degree acquired from the output of the machine learning model 13. The “line thickness” indicates the thickness of a line between nodes (relation) when the feature graph is displayed, and the “display color of line” indicates the display color of the line between the nodes when the feature graph is displayed. In the example of FIG. 11, when the contribution degree is “0.00 to 0.04”, the thickness of the line is “thickness 1”, and the display color of the line is “color A”; when the contribution degree is “0.05 to 0.08”, the thickness of the line is “thickness 2 (thickness 2>thickness 1)”, and the display color of the line is “color B”. As discussed above, the display format is set such that the larger the contribution degree, the more the display is highlighted.

The control unit 30 is a processing unit configured to manage the overall information processing apparatus 10, and includes a preprocessor 40 and an analysis section 50. The preprocessor 40 executes preliminary processing before the visualization of an estimation result of the machine learning model 13.

For example, the preprocessor 40 generates training data from the knowledge graph DB 14 by using the method described with reference to FIG. 5, and stores the generated training data in the training data DB 15. The preprocessor 40 receives the estimation target data 16a, the class data 16b, and the like from an administrator terminal or the like, and stores them in the estimation data DB 16. Similarly, the preprocessor 40 receives an ontology from the administrator terminal or the like and stores the ontology in the ontology DB 17, and receives a template from the administrator terminal or the like and stores the template in the template DB 18. The preprocessor 40 may not only accept the above-described data from the administrator terminal, but also automatically generate the data in accordance with a generation model, a generation rule, and the like generated in separate machine learning.

The preprocessor 40 generates the machine learning model 13 by machine learning using the training data stored in the training data DB 15. For example, the preprocessor 40 inputs graph data included in the training data to the machine learning model 13, and executes supervised learning of the machine learning model 13 in such a manner as to reduce an error between the output of the machine learning model 13 and a teacher label included in the training data, thereby generating the machine learning model 13.

The analysis section 50 performs estimation by using the generated machine learning model 13, and visualizes the estimation result. The analysis section 50 includes an estimation execution unit 51, a knowledge insertion unit 52, a structure generation unit 53, and a display output unit 54.

The estimation execution unit 51 executes estimation processing using the machine learning model 13. For example, the estimation execution unit 51 inputs the estimation target data 16a stored in the estimation data DB 16 to the machine learning model 13, and acquires an estimation result. The estimation execution unit 51 acquires a contribution degree associated with each of the relations between the plurality of nodes included in the graph structure indicating the relations between the nodes with respect to the estimation result.

In the above example, the machine learning model 13 outputs the “contribution degree” of each triple included in the estimation target data 16a together with the estimation result “Pathogenic” or “Benign” in accordance with the input of the estimation target data 16a. For example, the estimation execution unit 51 inputs the estimation target data 16a illustrated in FIG. 6 to the machine learning model 13 to acquire the estimation result illustrated in FIG. 10, and stores the estimation result in the estimation result DB 19. The contribution degree is also referred to as a confidence degree, a contribution ratio or the like, and a method for calculating the contribution degree or the like may employ a known method used for machine learning.

The knowledge insertion unit 52 extracts knowledge designated by an administrator or the like from the knowledge graph, and inserts the knowledge into the estimation result. For example, in order to facilitate understanding of the explanation on the estimation result of the machine learning model 13, the knowledge insertion unit 52 extracts, based on the information defined in the template, the corresponding data from the knowledge graph, and inserts the extracted data into the estimation result. For example, in a case where there is an explanation telling that “the structure change score is 0.8” in the template, the knowledge insertion unit 52 inserts a name, an explanation, and the like of an algorithm of a method for calculating the structure change score, as knowledge.

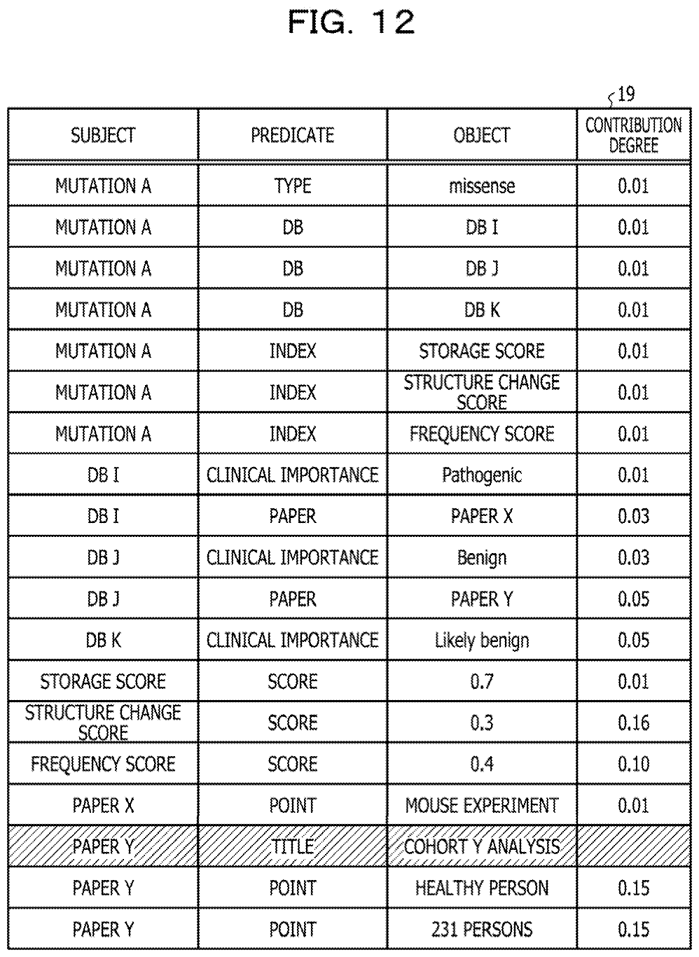

FIG. 12 is a table describing knowledge insertion. In FIG. 12, in order to simplify the description, the estimation value in FIG. 10 is omitted. As illustrated in FIG. 12, the knowledge insertion unit 52 inserts knowledge “subject (paper), predicate (title), object (cohort Y analysis)” into the estimation result illustrated in FIG. 10. At this time, since this knowledge is not included in the estimation target data 16a and does not contribute to the estimation, the knowledge insertion unit 52 sets the contribution degree to be “0”. For example, the knowledge insertion unit 52 adds a graph structure in which a node “paper” and a node “cohort Y analysis” are coupled by an edge “title”.

The structure generation unit 53 generates graph data in which, within the graph structure, the first structure indicating the first class to which one node or a plurality of nodes belongs and the second structure indicating the first node that belongs to the first class and has an associated contribution degree being equal to or larger than a threshold, are coupled to each other.

For example, the structure generation unit 53 determines, for a node belonging to a class not included in the ontology (a non-belonging node), whether to visualize the node based on the contribution degree of the relationship in which the above node is a “subject”. For a node belonging to a class included in the ontology (a belonging node), the structure generation unit 53 determines whether to visualize the node based on both the contribution degree of the relationship in which the above node is set to be a “subject” and the contribution degree of the relationship in which, when the above node is set to be the “subject”, a node “object” to be coupled on the opposite side is set to be a “subject”.

As described above, the structure generation unit 53 couples a node having a high contribution degree corresponding to the template to the aggregate node that is generated based on the ontology, thereby generating data of a graph structure in which the estimation grounds of the machine learning model 13 (hereafter referred to as visualization graph data in some cases) are visualized. Detailed processing of this will be described later.

The display output unit 54 outputs and displays the visualization graph data generated by the structure generation unit 53. For example, the display output unit 54 changes, in accordance with the definition information stored in the display format DB 20, the thickness, display color, and the like of each edge (relation, line) coupling the nodes in the visualization graph data, thereby generating the visualization graph data highlighted in accordance with the contribution degrees. The display output unit 54 stores the visualization graph data having been subjected to highlight display in the storage unit 12, and displays the visualization graph data on a display or the like or transmits the visualization graph data to an administrator terminal.

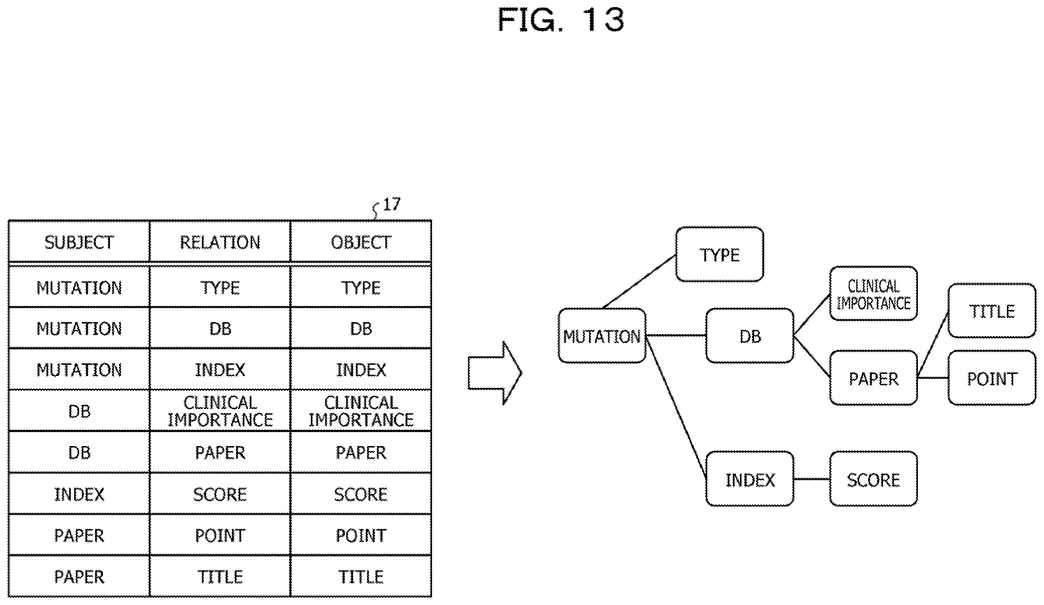

Next, a specific example of the generation of visualization graph data will be described with reference to FIG. 13 and the subsequent figures, where items having influence on the estimation are extracted. In the specific example, a threshold of a contribution degree is set to be “0.14” as an example. In the specific example, in order to simplify the description, the estimation value in FIG. 10 is omitted.

First, the structure generation unit 53 graphs an ontology after the knowledge insertion by the knowledge insertion unit 52. FIG. 13 is a diagram describing display of an ontology. As illustrated in FIG. 13, the structure generation unit 53 generates, based on the ontology stored in the ontology DB 17, graph data in which a node “subject” and a node “object” are coupled by an edge “relation”. In an example illustrated in FIG. 13, the structure generation unit 53 generates graph data in which a mutation, a type, a DB, an index, clinical importance, a paper, a title, a point, and a value are taken as nodes, and the nodes are coupled by “relation” of the ontology.

Subsequently, the structure generation unit 53 sequentially selects each node included in the estimation result stored in the estimation result DB 19, and determines whether to visualize the node.

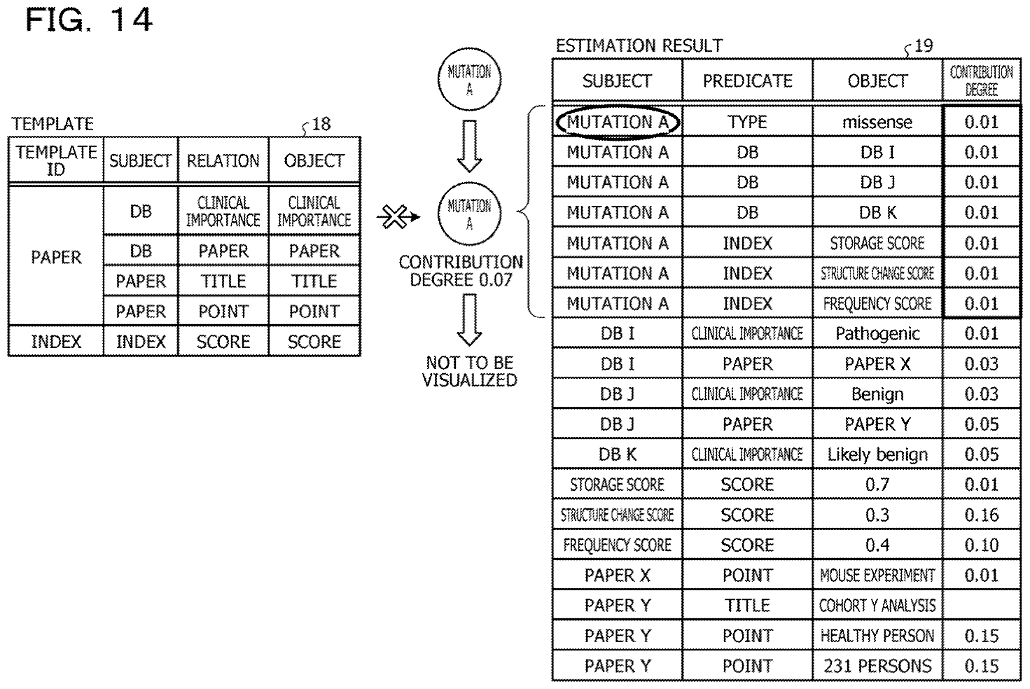

First, the structure generation unit 53 performs visualization determination on a “mutation A” of the estimation result. FIG. 14 is a diagram describing the visualization determination of the mutation A. As illustrated in FIG. 14, the structure generation unit 53 selects a subject “mutation A” from the estimation result, and specifies a class “mutation” corresponding to the “mutation A” with reference to the class data 16b. Then, the structure generation unit 53 refers to the template DB 18 and determines whether the class “mutation” is registered in the template.

Since the class “mutation” is not registered in the template, the structure generation unit 53 calculates a contribution degree only with the original subject “mutation A” that has specified the class “mutation”. For example, the structure generation unit 53 calculates the total of the contribution degrees of the subject “mutation A” as “0.07” based on the estimation result. As a result, since the contribution degree “0.07” of the subject “mutation A” is smaller than the threshold “0.14”, the structure generation unit 53 determines that the subject “mutation A” is not a target to be visualized.

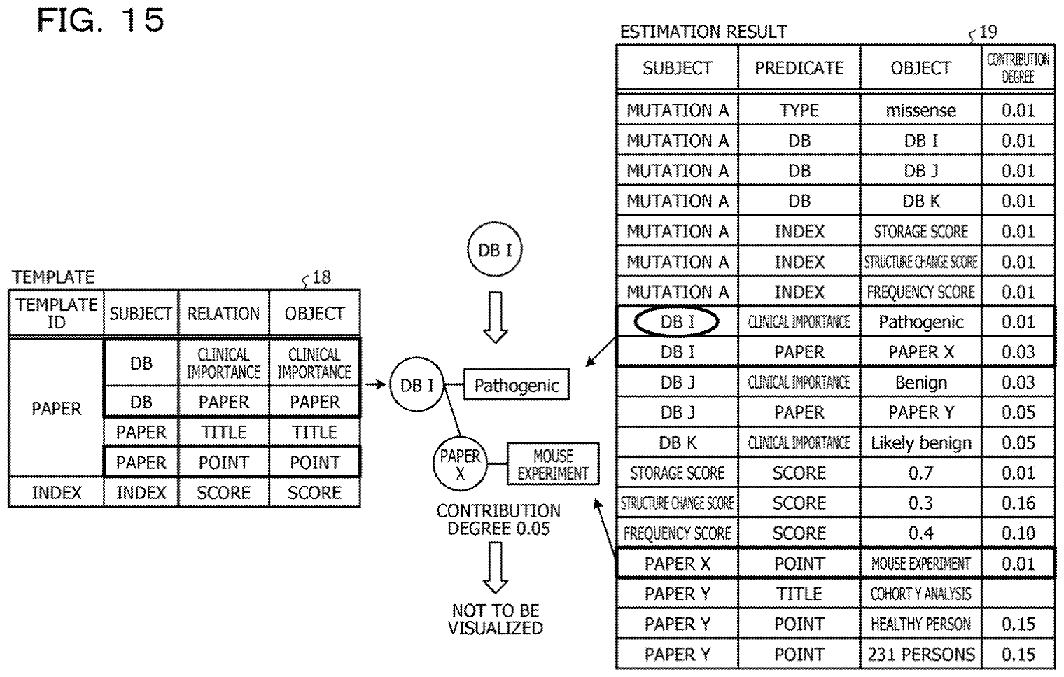

Next, the structure generation unit 53 performs visualization determination on a “DB I” of the estimation result. FIG. 15 is a diagram describing the visualization determination of the DB I. As illustrated in FIG. 15, the structure generation unit 53 selects a subject “DB I” from the estimation result, and specifies a class “DB” corresponding to the “DB I” with reference to the class data 16b. Then, the structure generation unit 53 refers to the template DB 18 and determines whether the class “DB” is registered in the template.

Since the class “DB” is registered in the template, the structure generation unit 53 calculates a contribution degree of the subject “DB I” by using the contribution degree regarding the node “DB I”, which is an example of the first node, and the contribution degree regarding the template of the class “DB”. For example, the structure generation unit 53 acquires a relationship of “subject: DB, relation: clinical importance, object: clinical importance” and “subject: DB, relation: paper, object: paper” from the template.

In this state, the structure generation unit 53 acquires, within the estimation result, the contribution degree “0.01” of “subject: DB I, predicate: clinical importance, object: Pathogenic”, and the contribution degree “0.03” of “subject: DB I, predicate: paper, object: paper X”, where the subject is “DB I”.

Since the estimation result includes “subject: paper X, predicate: point, object: mouse experiment” taking the “paper X”, which is an example of a second node, as a node, and the template registers a relationship from the class “DB” to a class “point” via a class “paper”, the structure generation unit 53 acquires a contribution degree “0.01” of the estimation result “subject: paper X, predicate: point, object: mouse experiment”.

As a result, the structure generation unit 53 calculates the contribution degree of the “DB I” of the estimation result as “0.01+0.03+0.01=0.05”. Since the contribution degree “0.05” of the subject “DB I” is smaller than the threshold “0.14”, the structure generation unit 53 determines that the subject “DB I” is not a target to be visualized.

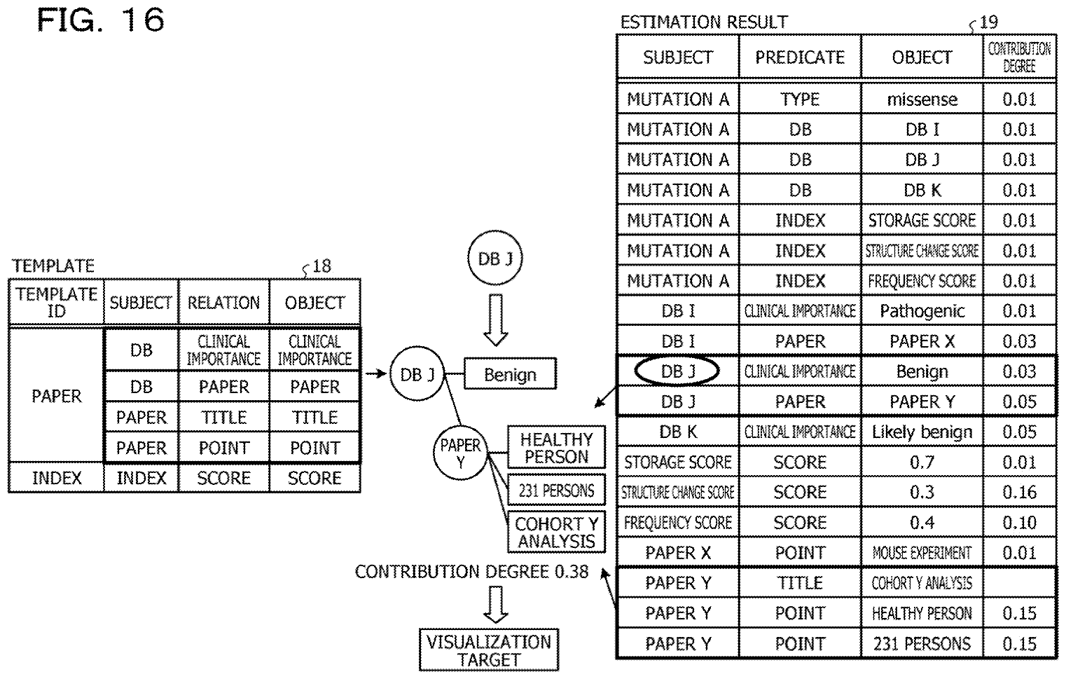

Next, the structure generation unit 53 performs visualization determination on a “DB J” of the estimation result. FIG. 16 is a diagram describing the visualization determination of the DB J. As illustrated in FIG. 16, the structure generation unit 53 selects a subject “DB J” from the estimation result, and specifies a class “DB” corresponding to the “DB J” with reference to the class data 16b. Then, the structure generation unit 53 refers to the template DB 18 and determines whether the class “DB” is registered in the template.

Since the class “DB” is registered in the template, the structure generation unit 53 calculates a contribution degree of the subject “DB J” by using the contribution degree regarding the node “DB J”, which is an example of the first node, and the contribution degree regarding the template of the class “DB”. For example, the structure generation unit 53 acquires a relationship of “subject: DB, relation: clinical importance, object: clinical importance” and “subject: DB, relation: paper, object: paper” from the template.

In this state, the structure generation unit 53 acquires, within the estimation result, the contribution degree “0.03” of “subject: DB J, predicate: clinical importance, object: Benign”, and the contribution degree “0.05” of “subject: DB J, predicate: paper, object: paper Y”, where the subject is “DB J”.

The structure generation unit 53 specifies that the estimation result includes “subject: paper Y, predicate: title, object: cohort Y analysis”, “subject: paper Y, predicate: point, object: healthy person”, and “subject: paper Y, predicate: point, object: 231 persons”, where the “paper Y”, which is an example of the second node, is taken as a node. Since a relationship with respect to the class “title” via the class “DB” or the class “paper”, and a relationship with respect to the class “point” via the class “DB” or the class “paper” are registered in the template, the structure generation unit 53 also acquires the contribution degrees thereof. For example, the structure generation unit 53 acquires the contribution degree “0” of “subject: paper Y, predicate: title, object: cohort Y analysis”, the contribution degree “0.15” of “subject: paper Y, predicate: point, object: healthy person”, and the contribution degree “0.15” of “subject: paper Y, predicate: point, object: 231 persons”.

As a result, the structure generation unit 53 calculates the contribution degree of the “DB J” of the estimation result as “0.03+0.05+0.15+0.15=0.38”. Since the contribution degree “0.38” of the subject “DB J” is not less than the threshold “0.14”, the structure generation unit 53 determines that the subject “DB J” is a target to be visualized.

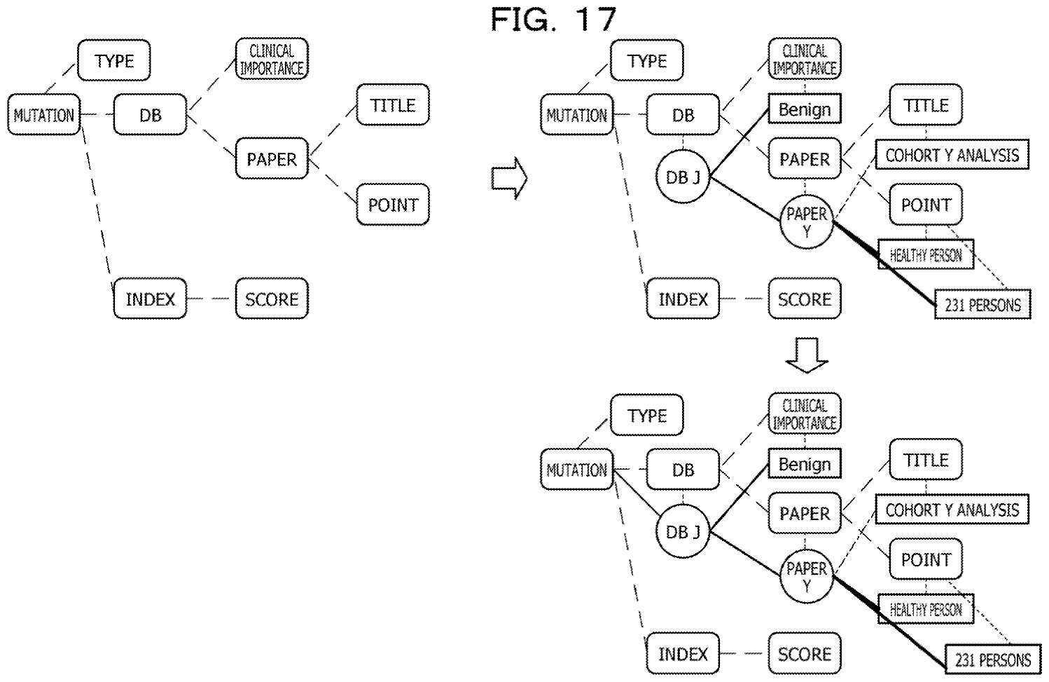

Then, the structure generation unit 53 makes a graph related to the node “DB J” of the estimation result appear in the feature graph as a third graph structure, and makes the graph visualized. FIG. 17 is a diagram describing the visualization of the DB J. As illustrated in FIG. 17, the structure generation unit 53 adds a graph structure of the node “DB J” corresponding to the second structure to the ontology corresponding to the first structure. For example, the structure generation unit 53 performs graphing such that “DB J, Benign, cohort analysis, 231 healthy persons” is coupled to “DB, clinical importance, paper, title, point” in the ontology. Further, the structure generation unit 53 couples the “DB J”, which is the second structure, to the “mutation” of the first structure, similar to the relationship between the “mutation” included in the first structure and the “DB”.

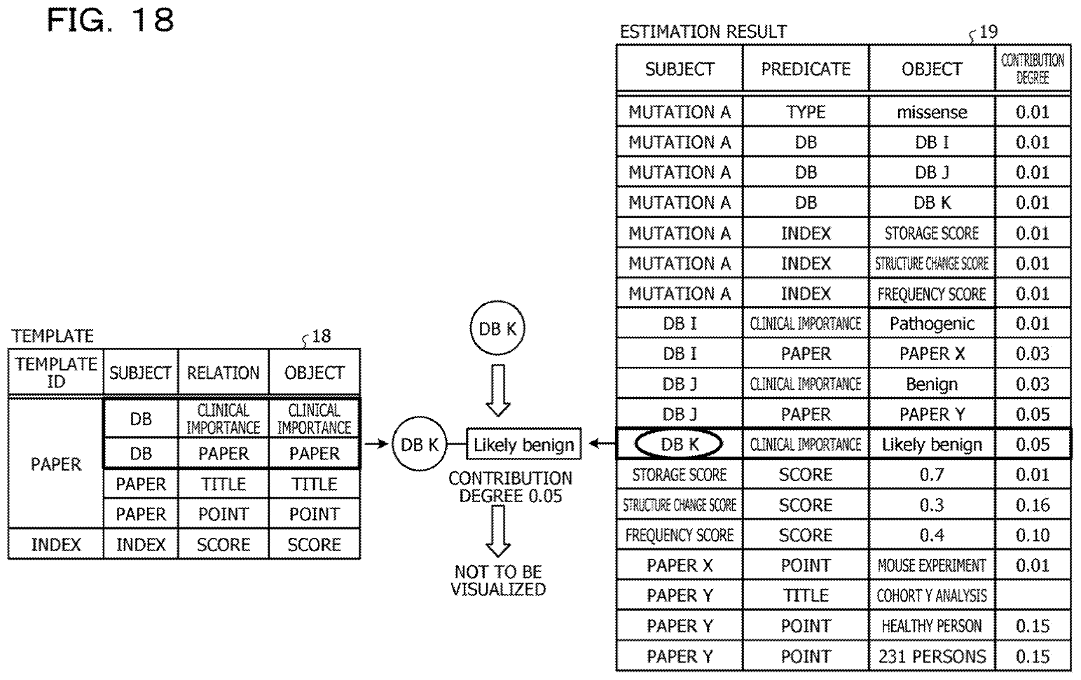

Next, the structure generation unit 53 performs visualization determination on a “DB K” of the estimation result. FIG. 18 is a diagram describing the visualization determination of the DB K. As illustrated in FIG. 18, the structure generation unit 53 selects a subject “DB K” from the estimation result, and specifies a class “DB” corresponding to the “DB K” with reference to the class data 16b. Then, the structure generation unit 53 refers to the template DB 18 and determines whether the class “DB” is registered in the template.

Since the class “DB” is registered in the template, the structure generation unit 53 calculates a contribution degree of the subject “DB K” by using the contribution degree regarding the node “DB K” and the contribution degree regarding the template of the class “DB”. For example, the structure generation unit 53 acquires a relationship of “subject: DB, relation: clinical importance, object: clinical importance” and “subject: DB, relation: paper, object: paper” from the template.

In this state, the structure generation unit 53 acquires, within the estimation result, the contribution degree “0.05” of “subject: DB K, predicate: clinical importance, object: Likely benign”, where the subject is “DB K”. Since the estimation result does not include the contribution degree corresponding to the template, the structure generation unit 53 does not acquire the contribution degree related to the template.

As a result, the structure generation unit 53 calculates the contribution degree of the “DB K” of the estimation result as “0.05”. Since the contribution degree “0.05” of the subject “DB K” is smaller than the threshold “0.14”, the structure generation unit 53 determines that the subject “DB K” is not a target to be visualized.

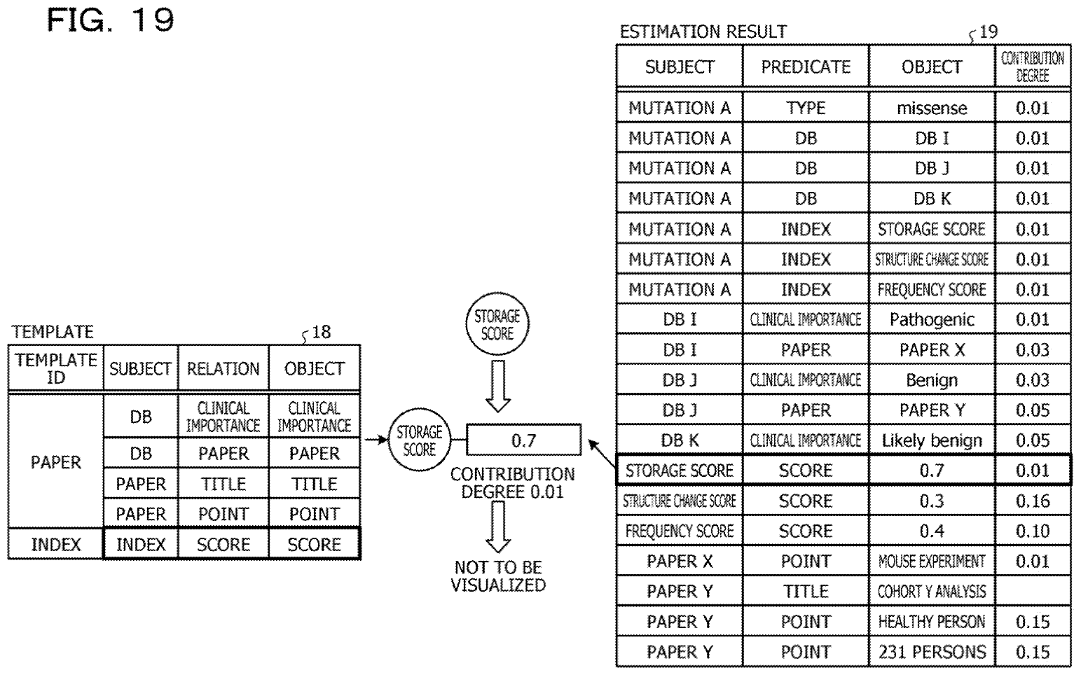

Next, the structure generation unit 53 performs visualization determination on a “storage score” of the estimation result. FIG. 19 is a diagram describing the visualization determination of the storage score. As illustrated in FIG. 19, the structure generation unit 53 selects a subject “storage score” from the estimation result, and specifies a class “index” corresponding to the “storage score” with reference to the class data 16b. Then, the structure generation unit 53 refers to the template DB 18 and determines whether the class “index” is registered in the template.

Since the class “index” is registered in the template, the structure generation unit 53 calculates a contribution degree of the subject “storage score” by using the contribution degree regarding the node “storage score” and the contribution degree regarding the template of the class “index”. For example, the structure generation unit 53 acquires a relationship of “subject: index, relation: score, object: score” from the template.

In this state, the structure generation unit 53 acquires, within the estimation result, the contribution degree “0.01” of “subject: storage score, predicate: score, object: 0.7”, where the subject is “storage score”. Since the estimation result does not include the contribution degree corresponding to the template, the structure generation unit 53 does not acquire the contribution degree related to the template.

As a result, the structure generation unit 53 calculates the contribution degree of the “storage score” of the estimation result as “0.01”. Since the contribution degree “0.01” of the subject “storage score” is smaller than the threshold “0.14”, the structure generation unit 53 determines that the subject “storage score” is not a target to be visualized.

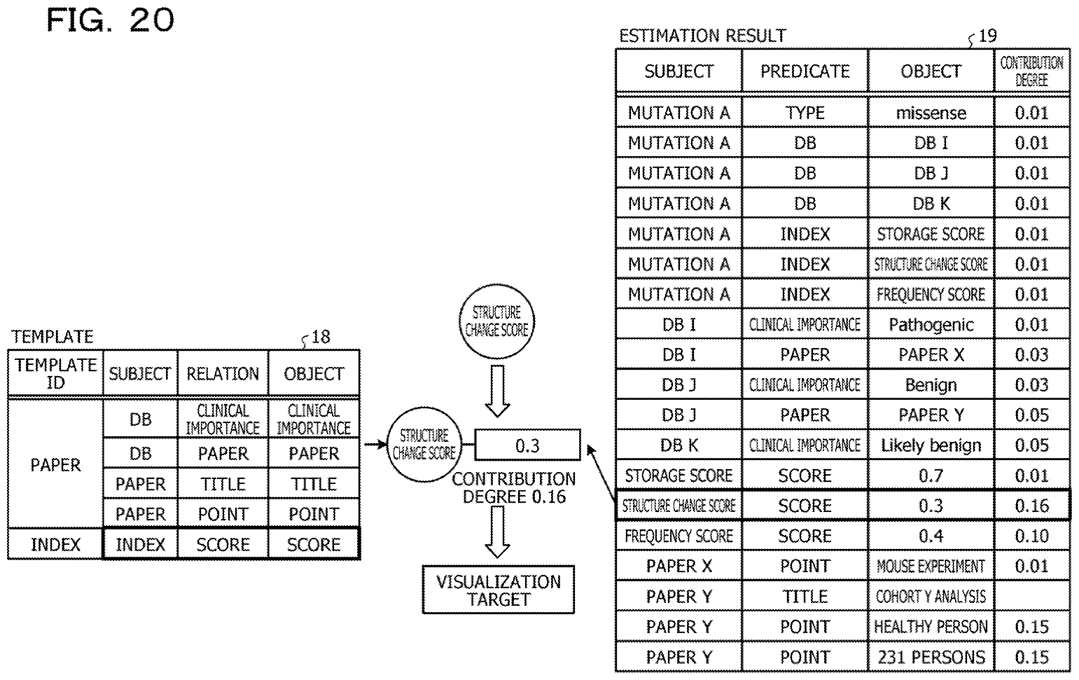

Next, the structure generation unit 53 performs visualization determination on a “structure change score” of the estimation result. FIG. 20 is a diagram describing the visualization determination of the structure change score. As illustrated in FIG. 20, the structure generation unit 53 selects a subject “structure change score” from the estimation result, and specifies a class “index” corresponding to the “structure change score” with reference to the class data 16b. Then, the structure generation unit 53 refers to the template DB 18 and determines whether the class “index” is registered in the template.

Since the class “index” is registered in the template, the structure generation unit 53 calculates a contribution degree of the subject “structure change score” by using the contribution degree regarding the node “structure change score” and the contribution degree regarding the template of the class “index”. For example, the structure generation unit 53 acquires a relationship of “subject: index, relation: score, object: score” from the template.

In this state, the structure generation unit 53 acquires, within the estimation result, the contribution degree “0.16” of “subject: structure change score, predicate: score, object: 0.3”, where the subject is “structure change score”. Since the estimation result does not include the contribution degree corresponding to the template, the structure generation unit 53 does not acquire the contribution degree related to the template.

As a result, the structure generation unit 53 calculates the contribution degree of the “structure change score” of the estimation result as “0.16”. Since the contribution degree “0.16” of the subject “structure change score” is not less than the threshold “0.14”, the structure generation unit 53 determines that the subject “structure change score” is a target to be visualized.

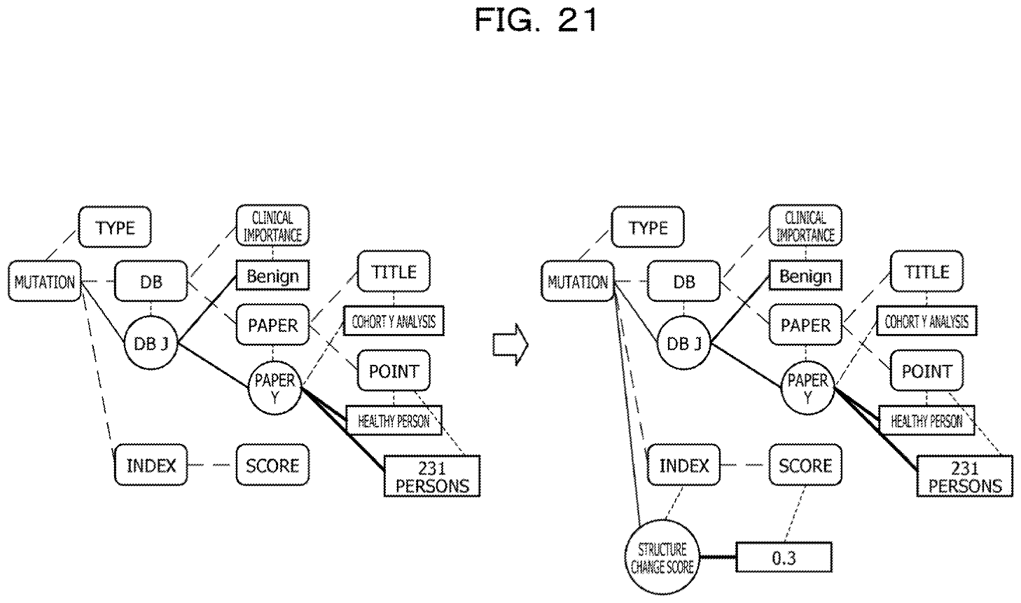

Then, the structure generation unit 53 makes the node “structure change score” of the estimation result appear in the feature graph, and makes the node visualized. FIG. 21 is a diagram describing the visualization of the structure change score. As illustrated in FIG. 21, the structure generation unit 53 adds a graph structure of the node “structure change score” corresponding to the second structure to the ontology corresponding to the first structure. For example, the structure generation unit 53 performs graphing such that “structure change score, 0.3” is coupled to “index, value” of the ontology. Further, the structure generation unit 53 couples the “structure change score”, which is the second structure, to the “mutation” of the first structure, similar to the relationship between the “mutation” included in the first structure and the “index”.

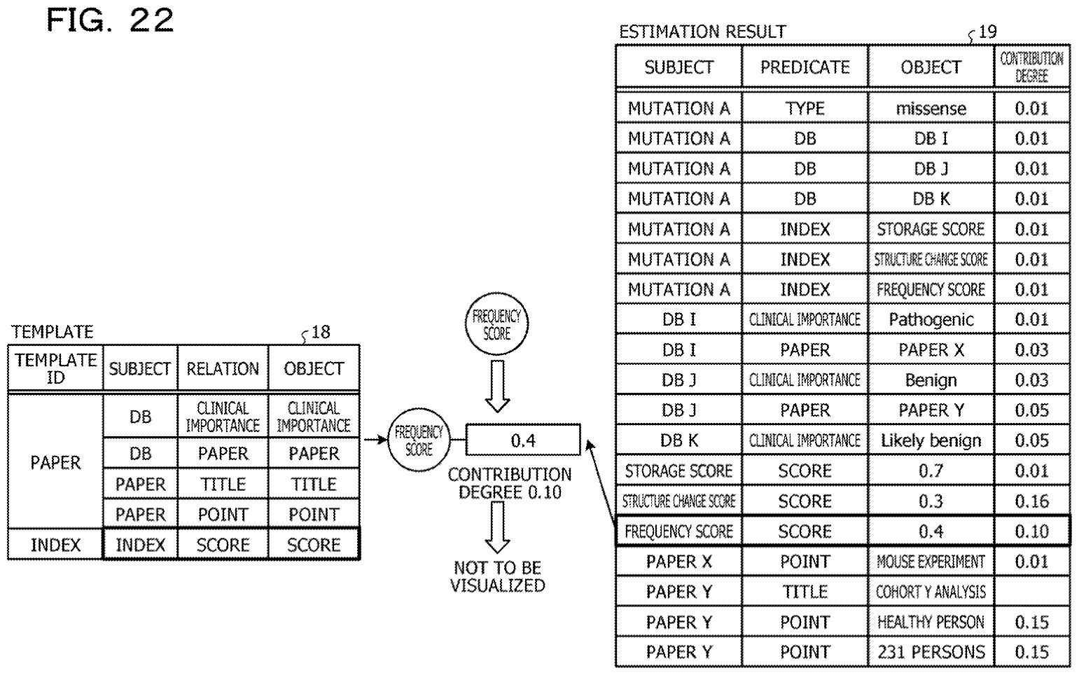

Next, the structure generation unit 53 performs visualization determination on a “frequency score” of the estimation result. FIG. 22 is a diagram describing the visualization determination of the frequency score. As illustrated in FIG. 22, the structure generation unit 53 selects a subject “frequency score” from the estimation result, and specifies a class “index” corresponding to the “frequency score” with reference to the class data 16b. Then, the structure generation unit 53 refers to the template DB 18 and determines whether the class “index” is registered in the template.

Since the class “index” is registered in the template, the structure generation unit 53 calculates a contribution degree of the subject “frequency score” by using the contribution degree regarding the node “frequency score” and the contribution degree regarding the template of the class “index”. For example, the structure generation unit 53 acquires a relationship of “subject: index, relation: score, object: score” from the template.

In this state, the structure generation unit 53 acquires, within the estimation result, the contribution degree “0.10” of “subject: frequency score, predicate: score, object: 0.4”, where the subject is “frequency score”. Since the estimation result does not include the contribution degree corresponding to the template, the structure generation unit 53 does not acquire the contribution degree related to the template.

As a result, the structure generation unit 53 calculates the contribution degree of the “frequency score” of the estimation result as “0.10”. Since the contribution degree “0.10” of the subject “frequency score” is smaller than the threshold “0.14”, the structure generation unit 53 determines that the subject “frequency score” is not a target to be visualized.

As described above, after the structure generation unit 53 performs the visualization determination on the estimation result, the display output unit 54 determines a display format in accordance with the contribution degree.

First, the display output unit 54 calculates a contribution degree between each of the nodes of the first structure by summing the contribution degrees other than those of the structure extracted in the second structure.

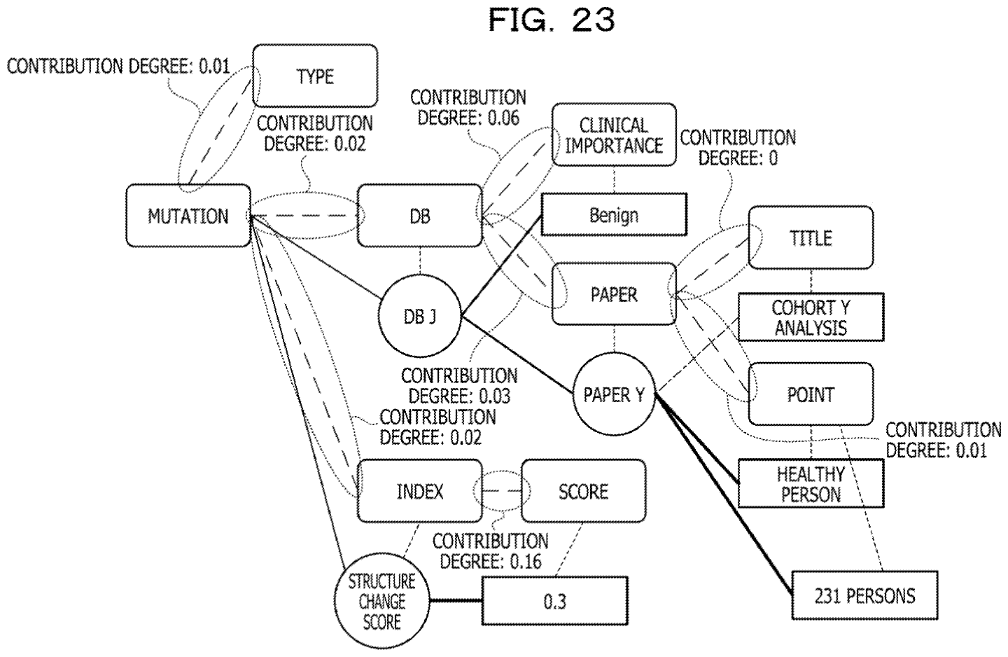

FIG. 23 is a diagram describing a contribution degree calculation of each edge of the first structure of visualization graph data. As illustrated in FIG. 23, since the second structure is not coupled for the class “mutation” and the class “type”, the display output unit 54 sets a contribution degree of “0.01” in accordance with the estimation result illustrated in FIG. 10. For the class “mutation” and the class “DB”, since the node “DB J” is coupled as the second structure, the display output unit 54 sets the total value of the contribution degrees while excluding the “DB J” from the estimation result illustrated in FIG. 10. For example, the display output unit 54 acquires “subject: mutation A, predicate: DB, object: DB I, contribution degree: 0.01” corresponding to the second node and “subject: mutation A, predicate: DB, object: DB K, contribution degree: 0.01” corresponding to a third node from the estimation result, and sets the total value “0.02” of the contribution degrees.

Likewise, as for the class “mutation” and the class “index”, since the node “structure change score” is coupled as the second structure, the display output unit 54 sets the total value of the contribution degrees while excluding the “structure change score” from the estimation result illustrated in FIG. 10. For example, the display output unit 54 acquires “subject: mutation A, predicate: index, object: storage score, contribution degree: 0.01” and “subject: mutation A, predicate: index, object: frequency score, contribution degree: 0.01” from the estimation result, and sets the total value “0.02” of the contribution degrees.

Likewise, as for the class “DB” and the class “clinical importance”, since a graph “DB J-Benign” is coupled as the second structure, the display output unit 54 sets the total value of the contribution degrees while excluding the “DB J-Benign” from the estimation result illustrated in FIG. 10. For example, the display output unit 54 acquires “subject: DB I, predicate: clinical importance, object: Pathogenic, contribution degree: 0.01” and “subject: DB K, predicate: clinical importance, object: Likely benign, contribution degree: 0.05” from the estimation result, and sets the total value “0.06” of the contribution degrees.

Likewise, as for the class “index” and the class “score”, since a graph “structure change score-0.3” is coupled as the second structure, the display output unit 54 sets the total value of the contribution degrees while excluding the “structure change score-0.3” from the estimation result illustrated in FIG. 10. For example, the display output unit 54 acquires “subject: storage score, predicate: score, object: 0.7, contribution degree: 0.01” and “subject: frequency score, predicate: score, object: 0.4, contribution degree: 0.10” from the estimation result, and sets the total value “0.11” of the contribution degrees.

With the above-discussed method, the display output unit 54 sets a contribution degree of “0.03” between the “DB” and the “paper”, a contribution degree of “0” between the “paper” and the “title”, and a contribution degree of “0.01” between the “paper” and the “point”.

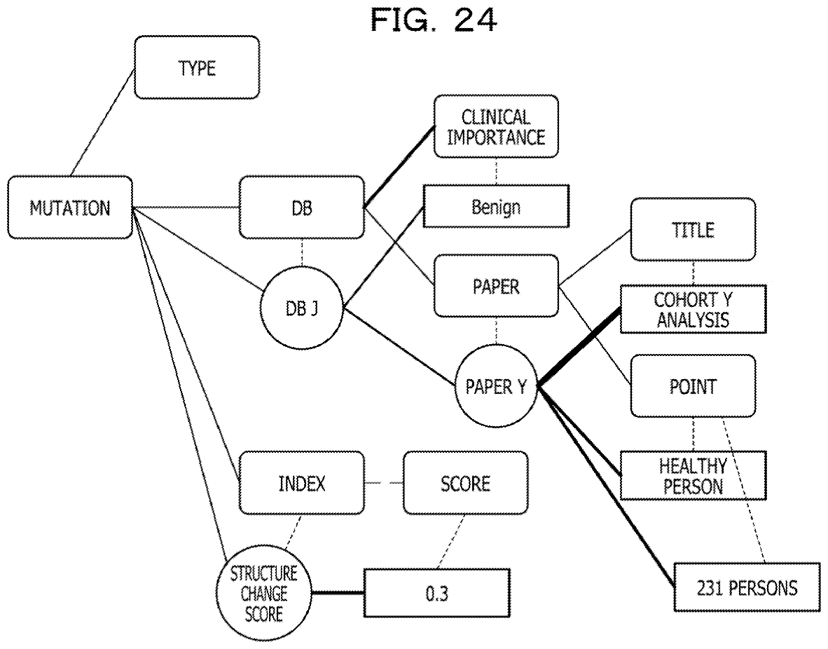

Thereafter, the display output unit 54 changes the thickness, the display color, and the like of each of the lines between the classes (nodes) in accordance with the information stored in the display format DB 20, and outputs the visualization graph data having been subjected to these changes. FIG. 24 is a diagram describing a display example of the visualization graph data. As illustrated in FIG. 24, the display output unit 54 highlights and displays coupling lines having a large contribution degree, such as a coupling line between a “paper” and a “healthy person”, a coupling line between the “paper” and “231 persons”, and a coupling line between a “structure change score” and “0.3”.

By displaying and outputting in this manner, a user such as an administrator may easily acquire information having a large contribution degree to the estimation result. The display example in FIG. 24 is merely an example, and is not intended to limit the relation between the contribution degrees and the display format, the numerical values of the contribution degrees, and the like.

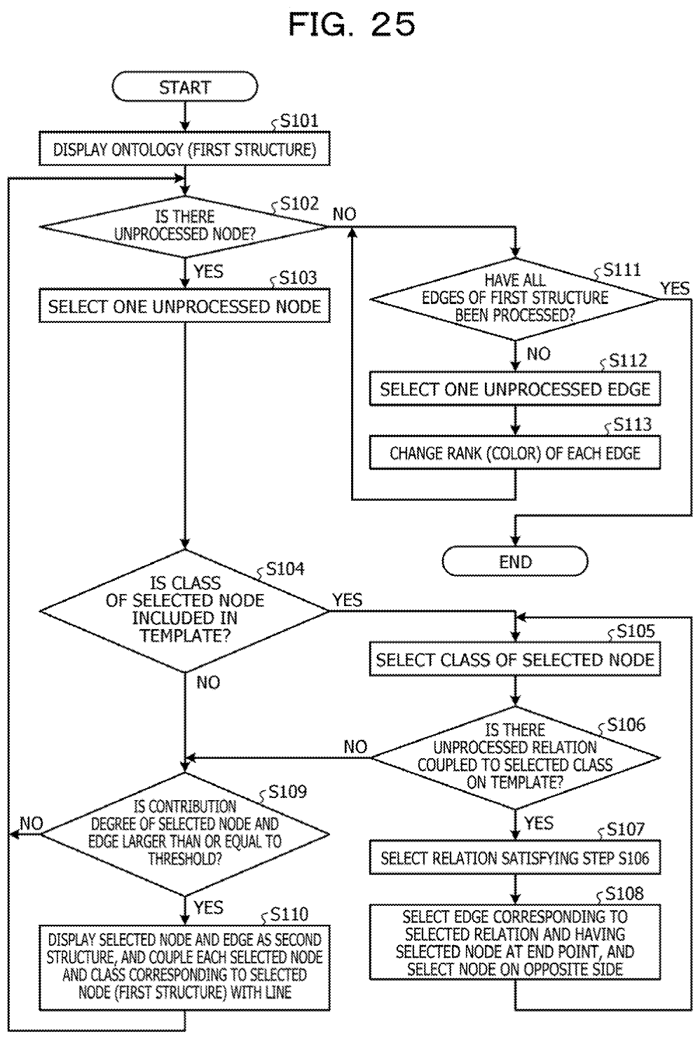

Next, a flow of the above-described visualization process will be described. FIG. 25 is a flowchart illustrating a flow of the visualization process. As illustrated in FIG. 25, when the process is started, the analysis section 50 displays an ontology that is the first structure by using information stored in the ontology DB 17 (S101).

Subsequently, when there is any unprocessed node in an estimation result (S102: Yes), the analysis section 50 selects one unprocessed node (S103). The analysis section 50 determines whether the class of the selected node is included in a template (S104).

In a case where the class of the selected node is included in the template (S104: Yes), the analysis section 50 selects the class of the selected node (S105), and determines whether there exists an unprocessed relation coupled to the selected class on the template (S106).

When there exists any relation satisfying S106 (S106: Yes), the analysis section 50 selects a relation satisfying step S106 (S107). Subsequently, the analysis section 50 selects an edge corresponding to the selected relation and having the selected node at an end point thereof, selects a node on the opposite side (S108), and repeats step S105 and the subsequent steps.

When there exists no relation satisfying step S106 (S106: No) or when the class of the selected node is not included in the template (S104: No), the analysis section 50 determines whether the contribution degree of the selected node and edge is equal to or larger than the threshold (S109).

When the contribution degree is equal to or larger than the threshold (S109: Yes), the analysis section 50 displays the selected node and edge as the second structure, couples each selected node to the corresponding class (first structure) with a line (S110), and repeats step S102 and the subsequent steps. Meanwhile, when the contribution degree is less than the threshold (S109: No), the analysis section 50 repeats step S102 and the subsequent steps without executing step S110 so as not to include the selected node in the graph as the second node.

In step S102, when there is no unprocessed node in the estimation result (S102: No), the analysis section 50 determines whether all edges of the first structure have been processed (S111).

When there exists any unprocessed edge (S111: No), the analysis section 50 selects one unprocessed edge (S112), and changes a rank (color or the like) of the edge (S113). For example, the analysis section 50 calculates a total contribution degree from the contribution degree of the edge that corresponds to the selected edge and is not displayed as the second structure, and changes the rank (color or the like) of the edge in accordance with the calculation result. When there is no unprocessed edge (S111: Yes), the analysis section 50 ends the visualization process.

As described above, the information processing apparatus 10 executes machine learning of a graph, assigns estimated contribution degrees to edges of the graph, aggregates nodes for each ontology, and displays the edges in accordance with the aggregated values of the contribution degrees of the aggregated edges. When a point at which the sum total of the contribution degrees of adjacent edges is large exceeds a threshold, the information processing apparatus 10 develops, as a representative example, a graph coupled to the above point in accordance with a template in which the ontology of the point is included.

As a result, the information processing apparatus 10 may determine whether to include the node in the first structure representing a class or to include in the second structure representing a single node depending on whether the contribution degree having contributed to the estimation of the machine learning model 13 is equal to or larger than the threshold, and may represent the graph by coupling those structures. This makes it possible for the information processing apparatus 10 to output information with which the grounds for the estimation by the machine learning model may be easily understood.

In addition, since the information processing apparatus 10 is able to identify and display an important estimation viewpoint by using the template, it is possible to suppress a situation in which the amount of information is excessively reduced to make it difficult to see the information. For example, in the example of FIG. 24, based on the display of “DB J-Benign” and “DB J-paper Y-healthy person”, the information processing apparatus 10 may present the grounds for the inference that “because 231 healthy persons having the same mutation are present, Benign is considered”. Further, based on the display of “mutation-index-score” and “structure change score-0.3”, the information processing apparatus 10 may present the grounds for the inference that “the calculated value of the structure change is 0.3, which is slightly low”.

The data examples, the numerical value examples, the thresholds, the display examples, the number of configuration examples of the graphs, the specific examples, and the like used in the above-described embodiment are merely examples, and may be optionally changed. As the training data, image data, audio data, time series data, and the like may be used; and the machine learning model 13 may also be used for image classification, various analyses, and the like.

In the above-described embodiment, an example in which contribution degrees are added to triples has been described, but the embodiment is not limited thereto, and the visualization determination may be performed in accordance with information obtained from the machine learning model. For example, even in a case where a contribution degree is added for each relation between two nodes or in a case where a contribution degree is added for each node, it is possible to perform the same processing by performing visualization determination for each relation between nodes or for each node instead of triples.

In the embodiment described above, the visualization determination based on the contribution degrees is performed also on nodes belonging to classes not included in an ontology which is the first structure, but the embodiment is not limited thereto. For example, nodes belonging to classes not included in the ontology may be excluded from the target on which the visualization determination is performed, and the visualization determination based on the contribution degrees may be performed only on nodes belonging to classes included in the ontology.

The ontology may be generated by using nodes obtained by excluding relations between the nodes with the contribution degrees being less than the threshold within the estimation result. The knowledge insertion described in the embodiment may be omitted. The template and the ontology may be processed as the same information.

Unless otherwise specified, processing procedures, control procedures, specific names, and information including various kinds of data and parameters described in the above-described document or drawings may be optionally changed.

Each element of each illustrated apparatus is of a functional concept, and may not be physically constituted as illustrated in the drawings. For example, the specific form of distribution or integration of each apparatus is not limited to that illustrated in the drawings. For example, the entirety or part of the apparatus may be constituted so as to be functionally or physically distributed or integrated in any units in accordance with various kinds of loads, usage states, or the like.

All or any part of the processing functions performed by each apparatus may be achieved by a central processing unit (CPU) and a program analyzed and executed by the CPU or may be achieved by a hardware apparatus using wired logic.

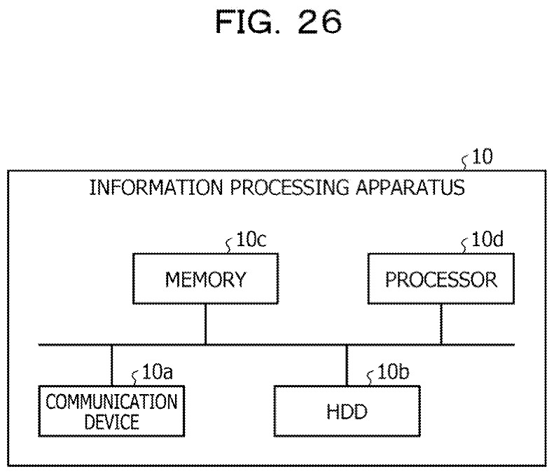

FIG. 26 is a diagram describing an example of a hardware configuration. As illustrated in FIG. 26, the information processing apparatus 10 includes a communication device 10a, a hard disk drive (HDD) 10b, a memory 10c, and a processor 10d. The constituent elements illustrated in FIG. 26 are coupled to one another by a bus or the like.

The communication device 10a is a network interface card or the like and communicates with other apparatuses. The HDD 10b stores programs for causing the functions illustrated in FIG. 4 to operate, a database (DB), and the like.

The processor 10d reads, from the HDD 10b or the like, programs that perform processing similar to the processing performed by the processing units illustrated in FIG. 4 and loads the read programs on the memory 10c, whereby a process that performs the functions described in FIG. 4 or the like is operated. For example, this process executes the functions similar to the functions of the processing units included in the information processing apparatus 10. For example, the processor 10d reads, from the HDD 10b or the like, programs that implement the same functions as those of the preprocessor 40, the analysis section 50, and the like. Then, the processor 10d executes the process that performs the same processing as that of the preprocessor 40, the analysis section 50, and the like.

As described above, the information processing apparatus 10 is operated as an information processing apparatus that performs a display method by reading and executing the programs. The information processing apparatus 10 may also achieve the functions similar to the functions of the above-described embodiment by reading out the above-described programs from a recording medium with a medium reading device and executing the above-described read programs. The programs described in another embodiment are not limited to the programs to be executed by the information processing apparatus 10. For example, the present disclosure may be similarly applied when another computer or server executes the programs or when another computer and server execute the programs in cooperation with each other.

The programs may be distributed via a network such as the Internet. The programs may be recorded on a computer-readable recording medium such as a hard disk, a flexible disk (FD), a compact disc read-only memory (CD-ROM), a magneto-optical disk (MO), or a Digital Versatile Disc (DVD), and may be executed by being read out from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a display program for causing a computer to execute a process, the process comprising:
acquiring a contribution degree associated with each of relations between a plurality of nodes included in a graph structure indicating the relations between the nodes with respect to an estimation result of a machine learning model; and
displaying a graph in which, within the graph structure, a first structure indicating a first class to which one node or a plurality of nodes belongs and a second structure indicating a first node that belongs to the first class and has the associated contribution degree being equal to or larger than a threshold, are coupled to each other.

2. The non-transitory computer-readable recording medium storing the display program for causing the computer to execute the process according to claim 1,
wherein the graph does not include a second node, of which the associated contribution degree is less than the threshold among the one node or the plurality of nodes.

3. The non-transitory computer-readable recording medium storing the display program for causing the computer to execute the process according to claim 1, the process further comprising:
calculating a total value of the contribution degree associated with the second node included in the one node or the plurality of nodes and the contribution degree associated with a third node coupled to the second node,
wherein the displaying a graph includes displaying the graph including a third structure indicating the second node and the third node in a case that the total value is equal to or larger than a threshold.

4. The non-transitory computer-readable recording medium storing the display program for causing the computer to execute the process according to claim 3,
wherein the calculating a sum total calculates the sum total in a case that the second node is a node that is coupled to the first node and belongs to the first class, and the associated contribution degree is equal to or greater than a threshold.

5. The non-transitory computer-readable recording medium storing the display program for causing the computer to execute the process according to claim 1,
wherein the displaying a graph includes displaying a relation between nodes contained in the graph in accordance with the contribution degree associated with the relation between the nodes in such a manner that the relation having a larger contribution degree is more highlighted.

6. An information processing apparatus comprising:
a memory; and
a processor coupled to the memory and configured to:
acquire a contribution degree associated with each of relations between a plurality of nodes included in a graph structure indicating the relations between the nodes with respect to an estimation result of a machine learning model; and
display a graph in which, within the graph structure, a first structure indicating a first class to which one node or a plurality of nodes belongs and a second structure indicating a first node that belongs to the first class and has the associated contribution degree being equal to or larger than a threshold, are coupled to each other.

7. A display method for causing a computer to execute a process, the process comprising:
acquiring a contribution degree associated with each of a plurality of triples included in a graph structure with respect to an estimation result of a machine learning model; and
displaying a graph that includes, within the graph structure, a first structure in which aggregated are triples that are included in the plurality of triples and related to a first attribute, and the contribution degrees of which are less than a threshold, and a second structure coupled to the first structure and indicating triples that are included in the plurality of triples and related to the first attribute, and the contribution degrees of which are equal to or larger than the threshold.
